(19) United States
(12) Patent Application Publication
(10) Pub. No.: US 2023/0130448 A1
(43) Pub. Date: Apr. 27, 2023

(54) SYSTEM AND METHOD FOR SEQUENTIAL DATA PROCESS MODELLING

(71) Applicant: ROYAL BANK OF CANADA, Toronto (CA)

(72) Inventors: Amir Hossein ABDI, Vancouver (CA); Lili MENG, Vancouver (CA); Gabriel Leivas OLIVEIRA, Vancouver (CA); Frederick TUNG, North Vancouver (CA)

(21) Appl. No.: 17/882,140

(22) Filed: Aug. 5, 2022

Related U.S. Application Data
(60) Provisional application No. 63/271,563, filed on Oct. 25, 2021.

(51) Int. Cl. G06N 3/04; G06N 3/08

(52) U.S. Cl. CPC G06N 3/0445; G06N 3/08

(57) ABSTRACT

A system for machine learning architecture for prospective resource allocations. The system may include a processor and a memory. The memory may store processor-executable instructions that, when executed, configure the processor to: receive a sequence of data records representing historical resource allocations from a user associated with a first identifier to another user associated with a second identifier; derive record features based on the sequence of data records representing the historical resource allocations for identifying irregular record features; determine a prospective resource allocation associated with the first identifier and the second identifier based on a neural network model and the derived record features; determine, based on the neural network model, a selection score associated with the prospective resource allocation; and when the selection score is above a minimum threshold, cause to display, at a display device, the prospective resource allocation corresponding to the second identifier.

### CROSS-REFERENCE TO RELATED APPLICATION

This application claims the benefit of and priority to U.S. provisional patent application No. 63/271,563, filed on Oct. 25, 2021, the entire content of which is herein incorporated by reference.

### FIELD

Embodiments of the present disclosure generally relate to the field of machine learning and, in particular, to machine learning architecture for sequential data process modelling.

### BACKGROUND

A resource pool may include one or more of currency, precious metals, computing resources, or other types of resources. Computing systems may be configured to execute data processes to allocate resources among data records associated with one or more entities. Such data records may be stored at one or more disparate data source devices, such as at disparate banking institutions, employer institutions, retail entities, or the like.

In some situations, data processes to allocate resources may be temporally recurring. For example, a customer user of a banking institution may conduct substantially periodic resource allocations over time to third party entities (e.g., paying user utility bills on a monthly basis, among other examples).

### SUMMARY

Embodiments of the present disclosure are directed to systems and methods for sequential data process modelling. In particular, systems and methods may be configured to receive a sequence of data records representing prior resource allocations and generate prospective data records representing prospective resource allocations for a future point in time.

In some embodiments, systems and methods may include machine learning architecture having machine learning models based on recurrent neural networks. In some embodiments, the recurrent neural networks may be configured to include residual long short-term memory (LSTM) networks.

In some situations, subsets of sequences of data records representing prior resource allocations may be irregular for forecasting prospective resource allocations. For example, a sequence of data records representing infrequent resource allocations (e.g., inconsistent utility bill payments, among other examples) or temporally inconsistent resource allocation intervals (e.g., unclear billing intervals, among other examples) may be irregular as data record inputs to machine learning models for generating prospective data records representing prospective resource allocations for a future point in time. It may be beneficial to configure machine learning models to conduct operations to identify one or more data records that may be associated with an irregular feature prior to modeling or forecasting prospective resource allocations.

In some embodiments, systems and methods may be configured to abstain from generating forecasted prospective resource allocations based on identified irregular data record inputs. In some examples, operations to abstain from generating forecasted prospective resource allocations may represent a balance among forecasting accuracy and input data set coverage (e.g., percentage of data record inputs for generating forecasted resource allocations).

In some situations, systems and methods for forecasting resource allocations at a future point in time may generate coarse grain or estimated resource allocation values. For example, coarse grain resource allocation values may include bill payment amounts rounded to the nearest dollar. It may be beneficial to provide systems and methods for generating forecasted resource allocation values with greater precision, such that auto-population of forecasted resource allocation values may be suitable for downstream user applications.

For example, generating forecasted resource allocation values with greater precision may provide input to an auto-populated user interface for seeking approval of the forecasted resource allocation.

In another example, generated forecasted resource allocation values with greater precision may provide downstream operations with inputs for generating user interfaces or alerts for identifying potential situations where insufficient resources may occur for future resource allocations. Such user interfaces may provide a banking institution customer/user with an indication of the user's “Cash©Hand” or other resource metric at a current or a future point-in-time.

Embodiments of systems and methods including machine learning models to forecast prospective resource allocations at a future point in time will be described in the present disclosure.

In one aspect, the present disclosure provides a system for machine learning architecture for prospective resource allocations. The system may include a processor and a memory coupled to the processor and storing processor-executable instructions that, when executed, configure the processor to: receive a sequence of data records representing historical resource allocations from a user associated with a first identifier to another user associated with a second identifier; derive record features based on the sequence of data records representing the historical resource allocations for identifying irregular record features; determine a prospective resource allocation associated with the first identifier and the second identifier based on a neural network model and the derived record features; determine, based on the neural network model, a selection score associated with the prospective resource allocation; and when the selection score is above a minimum threshold, cause to display, at a display device, the prospective resource allocation corresponding to the second identifier.

In some embodiments, the neural network model is based on a residual long short-term memory (LSTM) network including blocks of stacked LSTMs with residual connections between blocks.

In some embodiments, the neural network model is configured to generate one or more outputs associated with one or more time steps, the one or more outputs comprising a predicted date-delta, a predicted normalized amount, the selection score, and an auxiliary prediction including an auxiliary amount and an auxiliary date.

In some embodiments, training of the neural network model is based on the auxiliary amount and the auxiliary date.

In some embodiments, the processor-executable instructions, when executed, configure the processor to: based on the selection score, associate a weight with an identified data record corresponding to an irregular record feature.

In some embodiments, associating a zero weight to the identified data record marks the identified data record as the irregular record feature for abstaining from generating a prospective resource allocation.

In some embodiments, the processor-executable instructions, when executed, configure the processor to: generate one or more adjusted prospective resource allocations corresponding to the second identifier based on self-attention operations, wherein the adjusted prospective resource allocations comprise a dynamic weighted average of prior observed resource allocation values.

In some embodiments, the neural network model is associated with a network loss including a selective prediction loss expressed as:

$$\begin{matrix}{ℒ}_{( f , g )} {=}^{△} {\hat{r}}_{ℓ} ( f , g \vert {S}_{m} ) + λΨ ( c - \hat{ϕ} ( g \vert {S}_{m} ) ) \\ Ψ ( a ) {=}^{△} {max ( 0 , a )}^{2} ,\end{matrix}$$

$$wherein$$

$$\hat{r} ( f , g \vert {S}_{m} ) {=}^{△} \frac{\frac{1}{m} {\sum }_{i = 1}^{m} ℓ ( f ( {x}_{i} ) , {y}_{i} ) g ( {x}_{i} )}{\hat{ϕ} ( g \vert {S}_{m} )}$$

is a selective empirical risk, and

$$\hat{ϕ} ( g \vert {S}_{m} ) {=}^{△} \frac{1}{m} {{\sum }^{m}}_{i = 1} g ( {x}_{i} )$$

is a empirical coverage, f is a prediction function, g is a selection function for generating the selection score, c is a target coverage, lambda is a balancing hyper parameter, and psi is a quadratic penalty function.

In some embodiments, the network loss includes a combination of the selective prediction loss and an auxiliary loss expressed as:

$$ℒ = {αℒ}_{( f , g )} + ( 1 - α ) {ℒ}_{h}$$

$$wherein$$

$${ℒ}_{h} = \hat{r} ( h \vert {S}_{m} ) = \frac{1}{m} {{\sum }^{m}}_{i = 1} ℓ ( h ( {x}_{i} ) , {y}_{i} ) .$$

In another aspect, the present disclosure provides a computer-implemented method for machine learning architecture for prospective resource allocation, the method may include: receiving a sequence of data records representing historical resource allocations from a user associated with a first identifier to another user associated with a second identifier; deriving record features based on the sequence of data records representing the historical resource allocations for identifying irregular record features; determining a prospective resource allocation associated with the first identifier and the second identifier based on a neural network model and the derived record features; determining, based on the neural network model, a selection score associated with the prospective resource allocation; and when the selection score is above a minimum threshold, causing to display, at a display device, the prospective resource allocation corresponding to the second identifier.

In some embodiments, the neural network model is based on a residual long short-term memory (LSTM) network including blocks of stacked LSTMs with residual connections between blocks.

In some embodiments, the neural network model is configured to generate one or more outputs associated with one or more time steps, the one or more outputs comprising a predicted date-delta, a predicted normalized amount, the selection score, and an auxiliary prediction including an auxiliary amount and an auxiliary date.

In some embodiments, training of the neural network model is based on the auxiliary amount and the auxiliary date.

In some embodiments, the method further includes: based on the selection score, associating a weight with an identified data record corresponding to an irregular record feature.

In some embodiments, associating a zero weight to the identified data record marks the identified data record as the irregular record feature for abstaining from generating a prospective resource allocation.

In some embodiments, the method further includes: generating one or more adjusted prospective resource allocations corresponding to the second identifier based on self-attention operations, wherein the adjusted prospective resource allocations comprise a dynamic weighted average of prior observed resource allocation values.

In some embodiments, the neural network model is associated with a network loss including a selective prediction loss expressed as:

$$\begin{matrix}{ℒ}_{( f , g )} {=}^{△} {\hat{r}}_{ℓ} ( f , g \vert {S}_{m} ) + λΨ ( c - \hat{ϕ} ( g \vert {S}_{m} ) ) \\ Ψ ( a ) {=}^{△} {max ( 0 , a )}^{2} ,\end{matrix}$$

$$wherein$$

$$\hat{r} ( f , g \vert {S}_{m} ) {=}^{△} \frac{\frac{1}{m} {\sum }_{i = 1}^{m} ℓ ( f ( {x}_{i} ) , {y}_{i} ) g ( {x}_{i} )}{\hat{ϕ} ( g \vert {S}_{m} )}$$

is a selective empirical risk, and

$$\hat{ϕ} ( g \vert {S}_{m} ) {=}^{△} \frac{1}{m} {{\sum }^{m}}_{i = 1} g ( {x}_{i} )$$

is a empirical coverage, f is a prediction function, g is a selection function for generating the selection score, c is a target coverage, lambda is a balancing hyper parameter, and psi is a quadratic penalty function.

In some embodiments, the network loss includes a combination of the selective prediction loss and an auxiliary loss expressed as:

$$ℒ = {αℒ}_{( f , g )} + ( 1 - α ) {ℒ}_{h}$$

$$wherein$$

$${ℒ}_{h} = \hat{r} ( h \vert {S}_{m} ) = \frac{1}{m} {{\sum }^{m}}_{i = 1} ℓ ( h ( {x}_{i} ) , {y}_{i} ) .$$

In yet another aspect, the present disclosure provides a non-transitory computer-readable medium having stored thereon machine interpretable instructions which, when executed by a processor, cause the processor to perform: receiving a sequence of data records representing historical resource allocations from a user associated with a first identifier to another user associated with a second identifier; deriving record features based on the sequence of data records representing the historical resource allocations for identifying irregular record features; determining a prospective resource allocation associated with the first identifier and the second identifier based on a neural network model and the derived record features; determining, based on the neural network model, a selection score associated with the prospective resource allocation; and when the selection score is above a minimum threshold, causing to display, at a display device, the prospective resource allocation corresponding to the second identifier.

In some embodiments, the neural network model is based on a residual long short-term memory (LSTM) network including blocks of stacked LSTMs with residual connections between blocks.

In some embodiments, the neural network model is configured to generate one or more outputs associated with one or more time steps, the one or more outputs comprising a predicted date-delta, a predicted normalized amount, the selection score, and an auxiliary prediction including an auxiliary amount and an auxiliary date.

In some embodiments, training of the neural network model is based on the auxiliary amount and the auxiliary date.

In some embodiments, processor is further caused to perform: based on the selection score, associating a weight with an identified data record corresponding to an irregular record feature.

In some embodiments, associating a zero weight to the identified data record marks the identified data record as the irregular record feature for abstaining from generating a prospective resource allocation.

In some embodiments, processor is further caused to perform: generating one or more adjusted prospective resource allocations corresponding to the second identifier based on self-attention operations, wherein the adjusted prospective resource allocations comprise a dynamic weighted average of prior observed resource allocation values.

In some embodiments, the neural network model is associated with a network loss including a selective prediction loss expressed as:

$$\begin{matrix}{ℒ}_{( f , g )} {=}^{△} {\hat{r}}_{ℓ} ( f , g \vert {S}_{m} ) + λΨ ( c - \hat{ϕ} ( g \vert {S}_{m} ) ) \\ Ψ ( a ) {=}^{△} max {( 0 , a )}^{2} ,\end{matrix}$$

$$wherein$$

$$\hat{r} ( f , g \vert {S}_{m} ) {=}^{△} \frac{\frac{1}{m} {\sum }_{i = 1}^{m} ℓ ( f ( {x}_{i} ) , {y}_{i} ) g ( {x}_{i} )}{\hat{ϕ} ( g \vert {S}_{m} )}$$

is a selective empirical risk, and

$$\hat{ϕ} ( g \vert {S}_{m} ) {=}^{△} \frac{1}{m} {{\sum }^{m}}_{i = 1} g ( {x}_{i} )$$

is a empirical coverage, f is a prediction function, g is a selection function for generating the selection score, c is a target coverage, lambda is a balancing hyper parameter, and psi is a quadratic penalty function.

In some embodiments, the network loss includes a combination of the selective prediction loss and an auxiliary loss expressed as:

$$ℒ = {αℒ}_{( f , g )} + ( 1 - α ) {ℒ}_{h}$$

$$wherein$$

$${ℒ}_{h} = \hat{r} ( h \vert {S}_{m} ) = \frac{1}{m} {{\sum }^{m}}_{i = 1} ℓ ( h ( {x}_{i} ) , {y}_{i} ) .$$

In various further aspects, the disclosure provides corresponding systems and devices, and logic structures such as machine-executable coded instruction sets for implementing such systems, devices, and methods.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the present disclosure.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 illustrates a system, in accordance with embodiments of the present disclosure;

FIG. 2 illustrates a block diagram of a portion of a machine learning model including a residual long short-term memory network, in accordance with embodiments of the present disclosure;

FIG. 3 illustrates a block diagram of a portion of a machine learning model including a selective residual long short-term memory network, in accordance with embodiments of the present disclosure;

FIGS. 4 to 7 illustrate user interfaces for displaying forecasts of prospective resource allocations associated with a future point in time, in accordance with embodiments of the present disclosure; and

FIG. 8 illustrates a flowchart of a process, in accordance with embodiments of the present disclosure.

FIG. 9 shows a set of example utility bill amounts from a utility company.

FIG. 10 shows a set of example credit card bill amounts.

FIG. 11 shows a set of example tax amounts and another set of example credit card bill amounts.

FIG. 12 shows two sets of example store credit card amounts.

FIG. 13 shows another set of example utility bill amounts.

FIG. 14 shows a set of example internet and cable bill amounts.

FIG. 15 shows a set of example credit card bill amounts.

FIG. 16 shows another set of example credit card bill amounts.

FIG. 17 shows an example set of data records from a store with the effect of self-attention.

FIG. 18 an example set of data records from an insurance company with the effect of self-attention.

FIG. 19 shows an example set of data records from another insurance company with the effect of self-attention.

FIG. 20 shows an example set of data records from a utility company with the effect of self-attention.

### DETAILED DESCRIPTION

Embodiments of systems and methods including machine learning models configured to forecast prospective resource allocations at a future point in time will be described in the present disclosure.

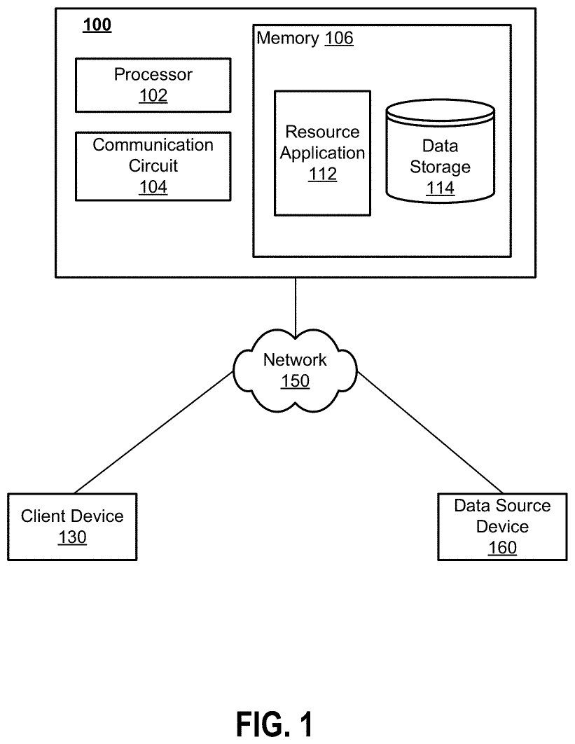

Reference is made to FIG. 1, which illustrates a system 100, in accordance with an embodiment of the present disclosure. The system 100 may transmit or receive data messages via a network 150 to or from a client device 130 or a data source device 160. A client device 130 and a data source device 160 are illustrated in FIG. 1; however, it may be understood that any number of client devices or data source devices may transmit or receive data messages to or from the system 100.

The network 150 may include a wired or wireless wide area network (WAN), local area network (LAN), a combination thereof, or other networks for carrying telecommunication signals. In some embodiments, network communications may be based on HTTP post requests or TCP connections. Other network communication operations or protocols may be contemplated.

The system 100 includes a processor 102 configured to implement processor-readable instructions that, when executed, configure the processor 102 to conduct operations described herein. For example, the system 100 may be configured to conduct operations of machine learning models to forecast prospective resource allocations for one or more future points in time. In some examples, the processor 102 may be a microprocessor or microcontroller, a digital signal processing processor, an integrated circuit, a field programmable gate array, a reconfigurable processor, or combinations thereof.

The system 100 includes a communication circuit 104 configured to transmit or receive data messages to or from other computing devices, to access or connect to network resources, or to perform other computing applications by connecting to a network (or multiple networks) capable of carrying data.

In some embodiments, the network 150 may include the Internet, Ethernet, plain old telephone service line, public switch telephone network, integrated services digital network, digital subscriber line, coaxial cable, fiber optics, satellite, mobile, wireless, SS7 signaling network, fixed line, local area network, wide area network, or other networks, including one or more combination of the networks. In some examples, the communication circuit 104 may include one or more busses, interconnects, wires, circuits, or other types of communication circuits. The communication circuit 104 may provide an interface for communicating data between components of a single device or circuit.

The system 100 includes memory 106. The memory 106 may include one or a combination of computer memory, such as random-access memory, read-only memory, electro-optical memory, magneto-optical memory, erasable programmable read-only memory, and electrically-erasable programmable read-only memory, ferroelectric random-access memory, or the like. In some embodiments, the memory 106 may be storage media, such as hard disk drives, solid state drives, optical drives, or other types of memory.

The memory 106 may store a resource application 112 including processor-readable instructions for conducting operations described herein. In some examples, the resource application 112 may include operations of machine learning models configured to forecast prospective resource allocations associated with future points in time. For example, determined resource availability for prospective resource allocations may represent a user's resource liquidity position associated with banking or monetary currency resources (e.g., how much “Cash©Hand” does a user have at a particular future point in time for providing for forecasted prospective resource allocations).

The system 100 includes data storage 114. In some embodiments, the data storage 114 may be a secure data store. In some embodiments, the data storage 114 may store resource data sets received from the data source device 160, data sets associated with historical resource transaction data, or other data sets for administering resource allocations among resource pools.

The client device 130 may be a computing device, such as a mobile smartphone device, a tablet device, a personal computer device, or a thin-client device. The client device 130 may be configured to operate with the system 100 for executing data processes to display forecasted or prospective resource allocations for display at a user interface. As will be described in the present disclosure, other operations may be conducted by the client device 130.

Respective client devices 130 may include a processor, a memory, or a communication interface, similar to the example processor, memory, or communication interfaces of the system 100. In some embodiments, the client device 130 may be a computing device associated with a local area network. The client device 130 may be connected to the local area network and may transmit one or more data sets to the system 200.

The data source device 160 may be a computing device, such as a data server, a database device, or other data storing system associated with resource transaction entities. For example, the data source device 160 may be associated with a banking institution providing banking accounts to users. The banking institutions may maintain bank account data sets associated with users associated with client devices 130, and the bank account data sets may be a record of monetary transactions representing credits (e.g., salary payroll payments, etc.) or debits (e.g., payments from the user's bank account to a vendor's bank account).

In another example, the data source device 160 may be associated with a vehicle manufacturer providing resource credit to a user associated with the client device 130. Terms of the resource credit may include periodic and recurring payments from a resource pool associated with the user (of the client device 130) to a resource pool associated with the vehicle manufacturer.

In some embodiments, systems described in the present disclosure may include machine learning architecture having machine learning models for generating forecasts of prospective resource allocations associated with a future point in time. In some situations, example machine learning models may generate outputs that are provided as input to downstream operations, thereby reduce occurrences of a resource pool (e.g., bank account) being overdrawn or having insufficient resources (e.g., lack of monetary funds) for prospectively forecasted resource allocations. The prospectively forecasted resource allocations may be based on trained machine learning models.

In some embodiments, the system 100 may be configured to conduct operations for dynamically or adaptively determining projected resource availability (e.g., resource liquidity position) based on the forecasted prospective resource allocations associated with the user of the client device 130.

In some embodiments, the machine learning models may be trained based on a sequence of data records representing prior resource allocations. For example, the sequence of data records may be a data set representing a sequence of transactions from a user account to a particular payee. Respective data records representing a transaction may include a date and a resource amount value. To illustrate, a data set may include:
Account: ###
Payee: HYDRO QUEBEC
2018-01-08, $209.33
2018-02-16, $470.01
2018-04-26, $287.54
2018-06-11, $194.23
2018-08-17, $165.72
2018-10-12, $158.47
2018-12-31, $237.91
2019-04-25, $337.07
2019-06-24, $213.72
2019-09-03, $211.25
2019-10-24, $151.79
2019-12-27, $229.41

In some embodiments, machine learning models may be trained based on data sets, where machine learning model training operations may be without regard for considering external or auxiliary data sets about the user or a prospective/intended payee.

In some embodiments, an input data set may be retrieved from one or more data source devices 160. For example, a data source device 160 may be an enterprise data warehouse (EDVV) associated with structured query language (SQL) data structures. Other examples of data source devices 160 and associated structures may be contemplated.

In some embodiments, the system 100 may include operations for pre-processing input data sets. Pre-processed input data sets may be configured for training embodiments of machine learning models or for generating forecasts of prospective resource allocations for particular users at a future point in time.

In some embodiments, the system 100 may include a one or more operations of an input pre-processing pipeline. Example operations may include:
reducing transactions made on the same day in the same sequence into a single transaction;
Remove sequences that consist of only a single transaction; or
For each sequence, extract the maximum transaction amount and normalize by this value (divide all amounts by this value). Store this value so that the normalization can be reversed at inference time.

Other examples of pre-processing input data sets may be used.

In some embodiments, the system 100 may include operations for deriving input data set features. For example, one or more input features identified from a sequence of data records representing resource transactions may include: for each transaction,

The date-delta (number of days) from the previous transaction in the sequence;

The normalized amount;

The day of the month;

The day of the week;

The month; or

The number of transactions in the sequence before this one in the same month.

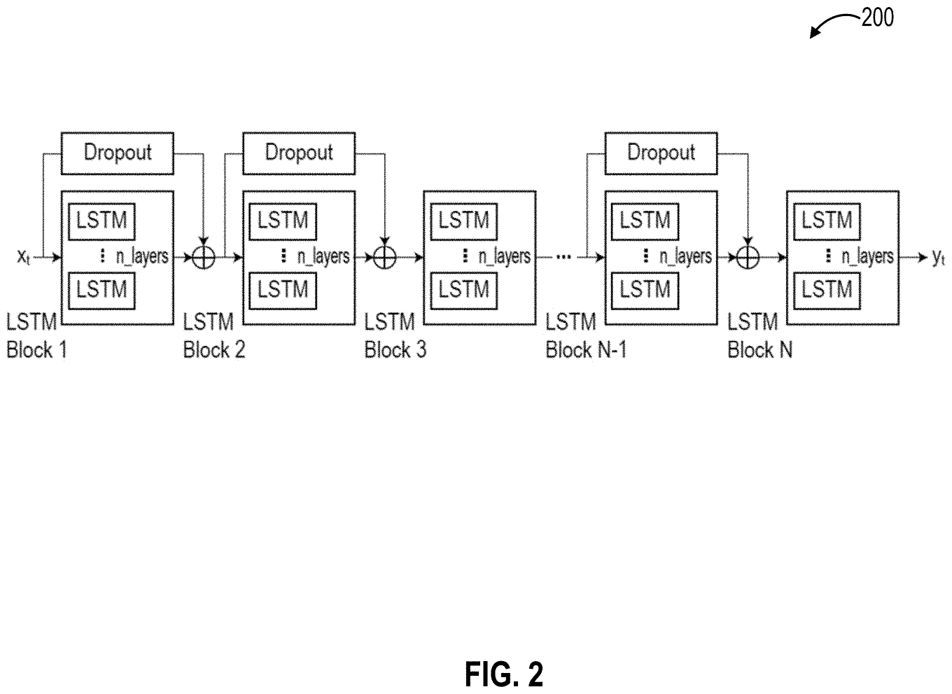

Reference is made to FIG. 2, which illustrates a block diagram 200 of a portion of a machine learning model including a residual long short-term memory (LSTM) network, in accordance with embodiments of the present disclosure. In some embodiments, the residual LSTM includes one or more blocks of stacked LSTMs with residual connections between blocks.

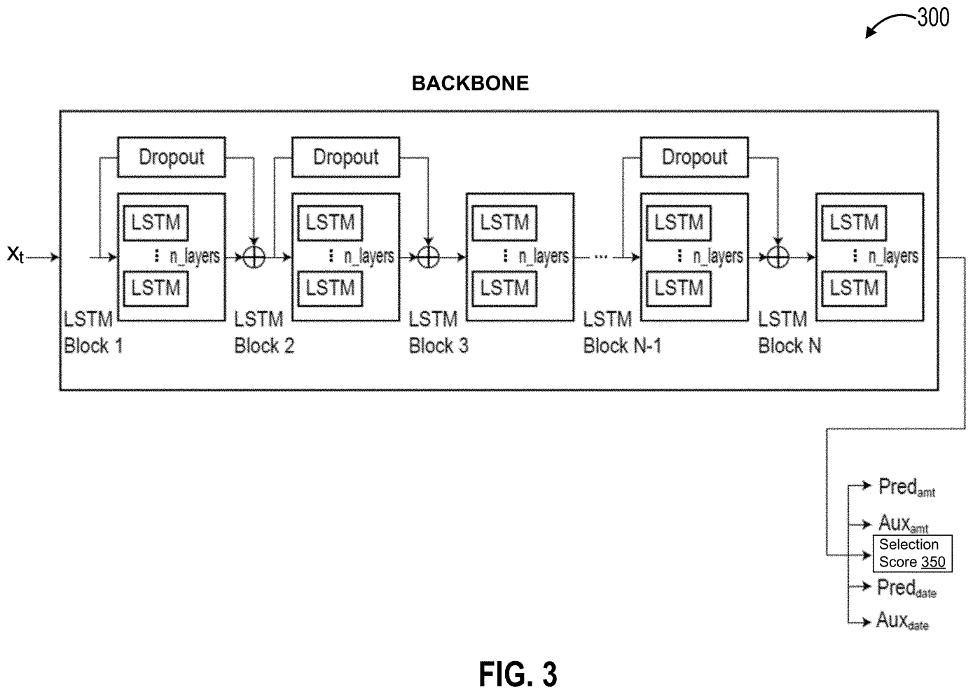

Reference is made to FIG. 3, which illustrates a block diagram 300 of a portion of a machine learning model including a selective residual LSTM network, in accordance with embodiments of the present disclosure.

In some embodiments, the selective residual LSTM network may be configured to generate outputs at successive time steps (e.g., following respective resource allocation transactions in a sequence). The outputs may be predicted date-delta (Pred_{date}), the predicted normalized amount (Predₐₘₜ), the selection score 350, or the auxiliary predictions (e.g., Auxₐₘₜ, Aux_{date}). In some embodiments, the generated outputs may be raw or unaltered machine learning model outputs that are provided as inputs to downstream operations. The downstream operations may interface with the selective residual LSTM network via application programmable interfaces (APIs). Other operations for interfacing with the selective residual LSTM network may be used.

In some embodiments, the auxiliary prediction values, such as the auxiliary predicted date-delta and normalized amount, may be provided for machine learning operations, for generating an auxiliary loss value (described as an example in the present disclosure).

In some embodiments, the selective residual LSTM network may be dynamic and may adapt to an actual payment behaviour of a user. As an example, the selective residual LSTM network may automatically or pre-emptively adjust to unexpected one-off resource allocation transactions or newly emerging resource allocation transaction patterns.

In some embodiments, the selection score may be dynamically determined, such that the machine learning models may be configured to continuously re-evaluate whether data set inputs or machine learning model outputs may predict prospective resource allocations for future points in time with sufficiently high confidence beyond a threshold value.

In some embodiments, selection score may be generated based on an integrated reject option built into a machine learning model. Some prospective resource allocation transaction sequences may be challenging to predict. For example, some sequences of resource allocation transactions may have features representing infrequent bill payments for retailer credit cards, sequences with many missed or extra payments, or sequences with unclear billing intervals. With such sequences of data records representing prior resource allocation transactions, it may be challenging to train a machine learning model to reliably predict sequences of data records representing resource allocation transactions. Machine learning training operations based on such irregular sequences of data records may hinder machine learning models from training based on more optimal sequences of data records representing relatively stable or generalizable patterns of resource allocation transactions.

In some examples, the system 100 may be configured to conduct manually created rules to define a subset of data records identified as regular or irregular. For example, manually created rules may include: “if the sequence of data records representing prior resource allocation transactions consists of more than X gaps of Y days, and the median gap is Z, then the sequence may be irregular”. However, such manually configured operations may not be scalable.

In some embodiments, the system 100 may include machine learning architecture configured to conduct operations implementing a “reject option”. The example “reject option” may be a machine learning model output representing a decision to abstain from making a prediction based on data records that may be identified as uncertain.

In addition to determining usual prediction or forecasting targets (e.g. the date and amount of the next transaction), in some embodiments, machine learning models may be configured to conduct operations to include an integrated reject option, thereby learning to output a “selection” score. A selection score may be a real-valued score to provide an indication on whether the machine learning model should abstain from making any predictions based on an identified sequence of data record input.

In some embodiments, a selection score may be a real-valued score, generated for a predicted value such as a predicted or prospective resource allocation amount, to provide an determination on whether the predicted or prospective resource allocation amount is a valid prediction. In cases where the selection score is higher than a minimum threshold, the corresponding predicted or prospective resource allocation amount may be stored as a valid prediction and presented for display at a client device 130, or used for further operation.

Thus, machine learning models configured to conduct operations with a selection score may represent a balance among forecasting accuracy and input data set coverage (e.g., percentage of inputs for which the machine learning model may generate a prediction of a prospective resource allocation at a future point in time.

In some embodiments, the generated selection score may indicate whether a generated prediction of a prospective resource allocation be: (i) rejected or withheld; or (ii) be provided for display or for a downstream operation of example systems described herein. In some embodiments, a selective loss expression may penalize a machine learning network if a specific level of coverage is not met (e.g., predictions may be required to be made 40% of the time). In the present examples, methods thereby may not assume a particular parametric model for the data distribution, and may optimize for coverage directly and focus on more predictable data.

In some examples, the machine learning model may be implemented and trained to generate forecasted data for resource allocation. For example, the system may be implemented to generate a prediction for electricity usage for one or more households at a future point in time, based on a sequence of historical data records. Each historical data record may include electricity consumption at a particular user location at a specific point in time in the past. Based on a sequence of such historical data records, the system may generate a prediction for electricity consumption at a future point in time, and a corresponding selection score indicating if the predicted electricity consumption is likely a valid prediction. When the selection score is above a minimum threshold, the predicted electricity consumption may be used for downstream processing, such as, for example, displaying at a electronic device, or used by the electricity provider for planning purposes.

In some examples, the machine learning model may be implemented and trained to generate forecasted data for weather forecasting. For example, the system may be implemented to generate a prediction for rainfall amount for a geographical location (e.g., Toronto) at a future point in time, based on a sequence of historical data records. Each historical data record may include rainfall at the same geographical location at a specific point in time in the past. Based on a sequence of such historical data records in a past month or season, the system may generate a prediction for rainfall at a future point in time, and a corresponding selection score indicating if the predicted rainfall is likely a valid prediction. When the selection score is above a minimum threshold, the predicted rainfall amount may be used for downstream processing, such as, for example, displaying at a electronic device as weather forecast.

In some examples, the machine learning model may be implemented and trained to generate forecasted data for property valuation. For example, the system may be implemented to generate a prediction for a market value for a property at a future point in time, based on a sequence of historical data records. Each historical data record may include market price for the same house or a similar house in the neighborhood at a specific point in time in the past. Based on a sequence of such historical data records, the system may generate a prediction for the market value for a property at a future point in time, and a corresponding selection score indicating if the predicted market value is likely a valid prediction. When the selection score is above a minimum threshold, the predicted market value may be used for downstream processing, such as, for example, displaying at a electronic device, or used by mortgage providers for providing loans and mortgages for purchasing said house.

In some examples, the machine learning model may be implemented and trained to generate forecasted data for inventory allocation. For example, the system may be implemented to generate a prediction for an amount of purchase orders for a certain product or a certain type of products at a future point in time, based on a sequence of historical data records. Each historical data record may include past purchase order amounts for the same product or same type of products at a specific point in time in the past. Based on a sequence of such historical data records, the system may generate a prediction for an amount of purchase orders for the product or the specific type of products at a future point in time, and a corresponding selection score indicating if the predicted amount of purchase orders is likely a valid prediction. When the selection score is above a minimum threshold, the predicted amount of purchase orders may be used for downstream processing, such as, for example, displaying at a electronic device, or used by retailers or manufactures for planning purposes.

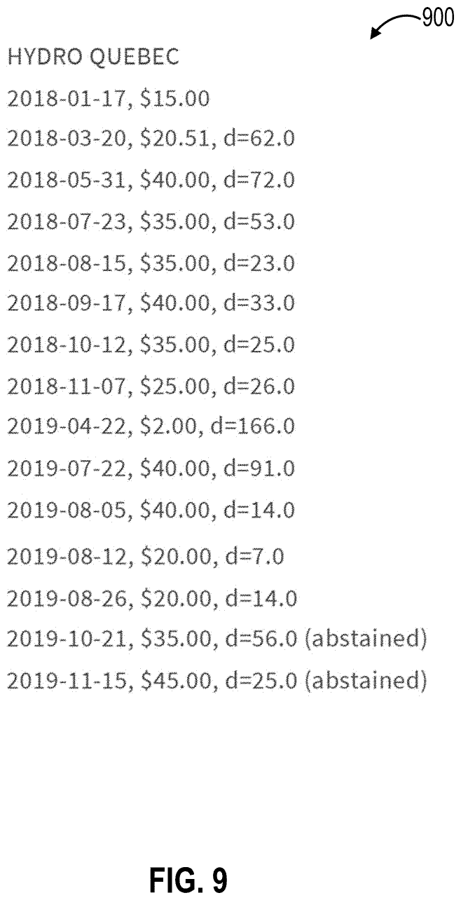

To illustrate, FIGS. 9 to 16 show example qualitative results associated with user bill payments having the following parameters: model coverage=33%; accuracy within 3 days=65%, with a test period from October 2019 to December 2019.

FIG. 9 shows a set of example utility bill amounts 900 from a utility company (Hydro Quebec). As indicated in the last two rows of data, when the number of days between two consecutive payment dates is irregular at 56 days (Oct. 21, 2019), the data is abstained.

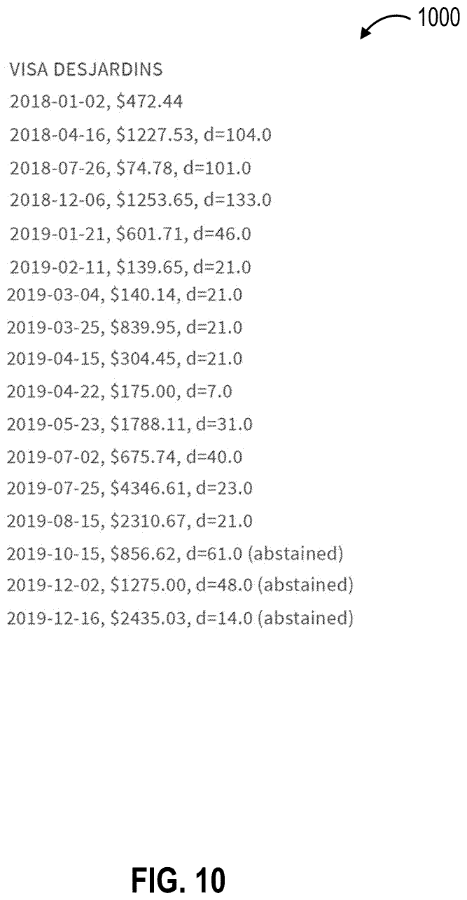

FIG. 10 shows a set of example credit card bill amounts 1000. The data records from the last three rows of data are abstained as they are categorized as being irregular.

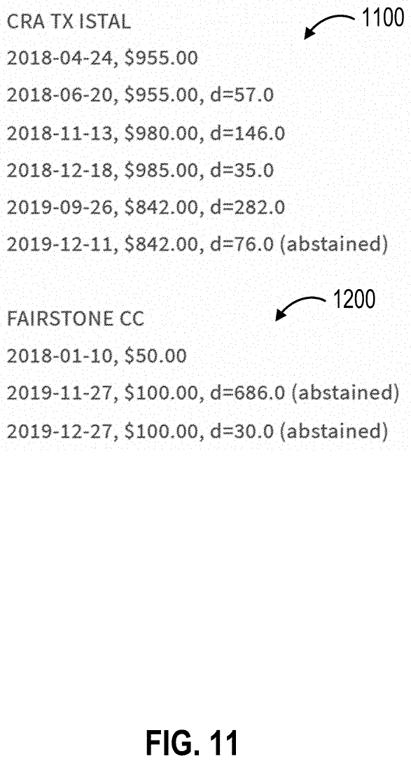

FIG. 11 shows a set of example tax amounts 1100 and another set of example credit card bill amounts 1200. Some data records are abstained as they are categorized as being irregular.

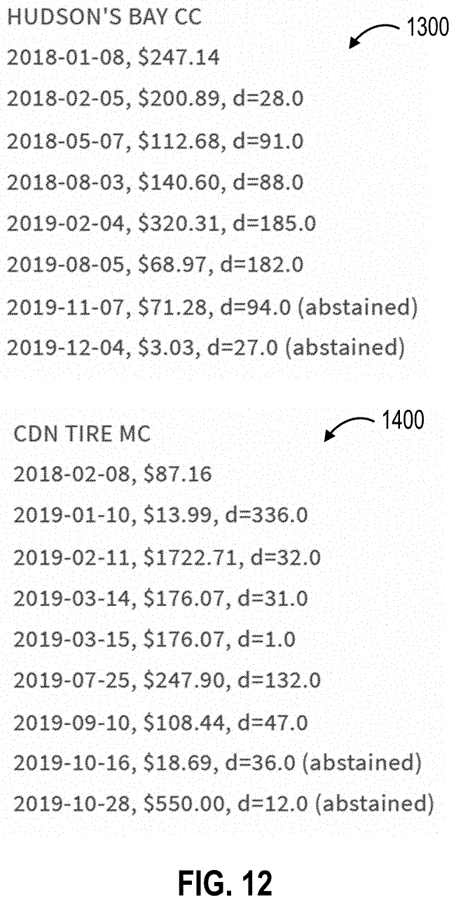

FIG. 12 shows two sets of example store credit card amounts 1300, 1400. Some data records are abstained as they are categorized as being irregular.

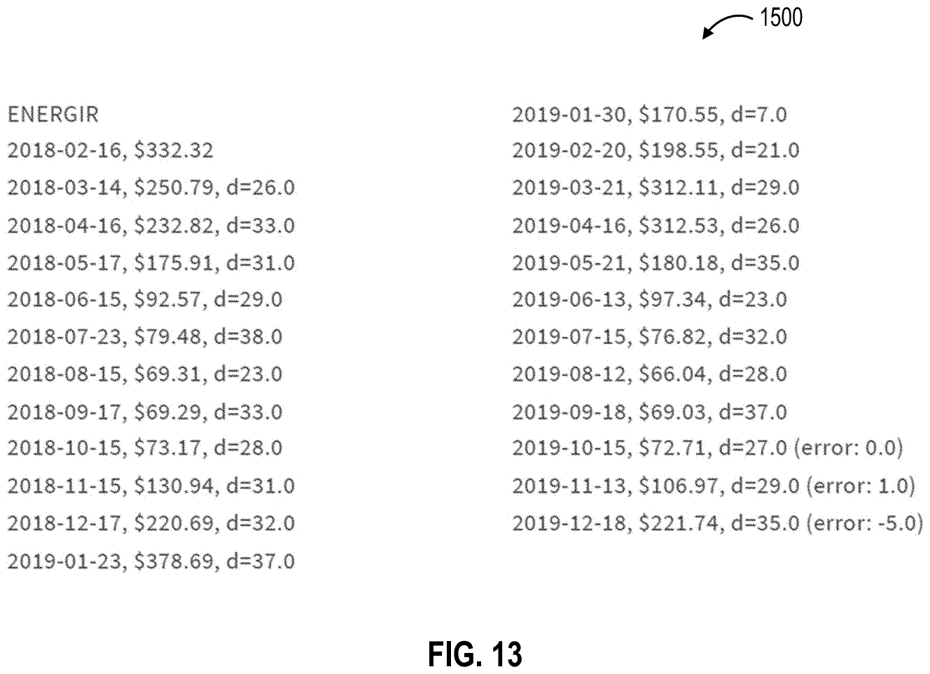

FIG. 13 shows another set of example utility bill amounts 1500. The data records from the last three rows of data are indicated with an error value based on how much the number of days between payments, represented by the variable “d”, differs from a predicted value.

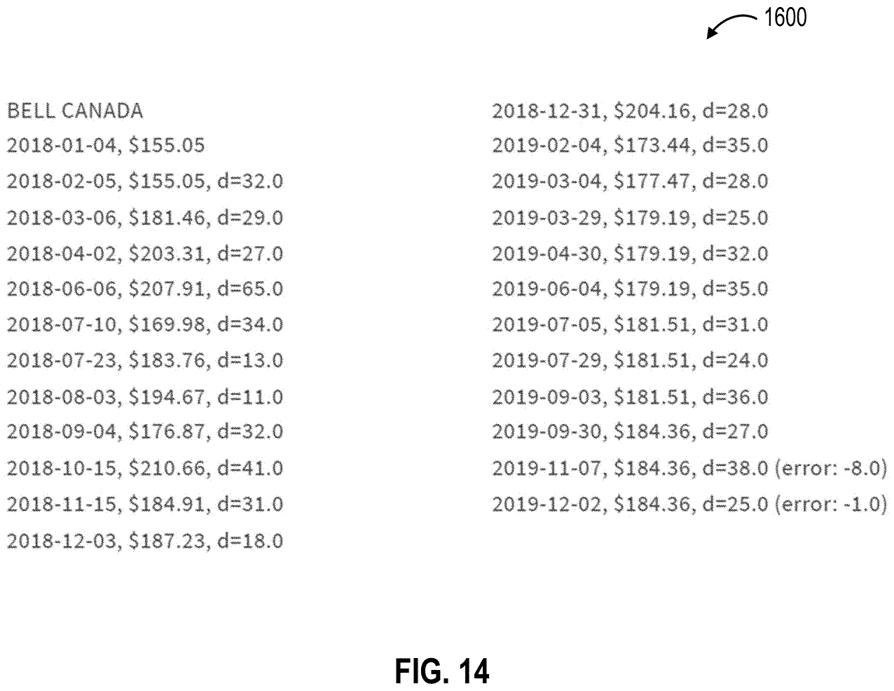

FIG. 14 shows a set of example internet and cable bill amounts 1600. The data records from the last two rows of data are indicated with an error value based on how much the number of days between payments, represented by the variable “d”, differs from a predicted value.

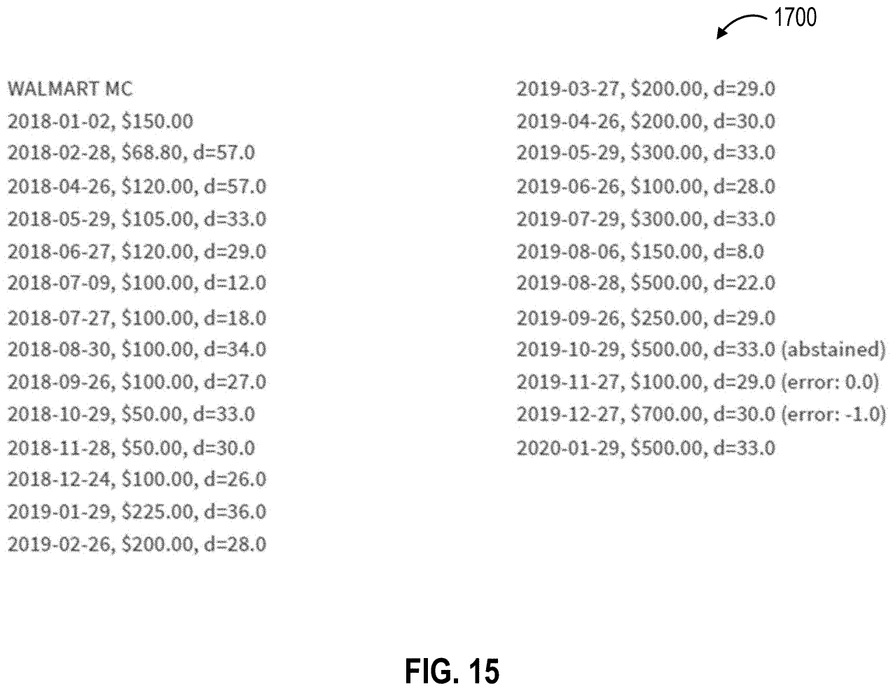

FIG. 15 shows a set of example credit card bill amounts 1700. Some data records are abstained while some data records are indicated with an error value. In some cases, the error value may be the difference between a predicted value and the correct (e.g., ground-truth) value.

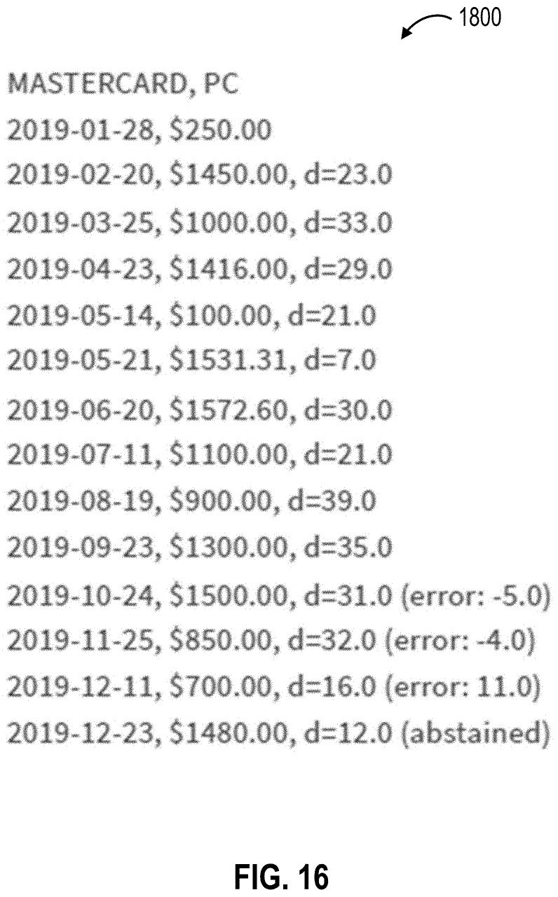

FIG. 16 shows another set of example credit card bill amounts 1800. Some data records are abstained while some data records are indicated with an error value. In some cases, the error value may be generate based on the selection score and used to decide if a data record should be abstained from downstream operation.

In some embodiments, machine learning models described in the present disclosure may have a selective prediction loss generally expressed as:

$$\begin{matrix}{ℒ}_{( f , g )} {=}^{△} {\hat{r}}_{ℓ} ( f , g \vert {S}_{m} ) + λΨ ( c - \hat{ϕ} ( g \vert {S}_{m} ) ) \\ Ψ ( a ) {=}^{△} max {( 0 , a )}^{2} ,\end{matrix}$$

$$where$$

$$\hat{r} ( f , g \vert {S}_{m} ) {=}^{△} \frac{\frac{1}{m} {\sum }_{i = 1}^{m} ℓ ( f ( {x}_{i} ) , {y}_{i} ) g ( {x}_{i} )}{\hat{ϕ} ( g \vert {S}_{m} )}$$

may be the selective empirical risk, and

$$\hat{ϕ} ( g \vert {S}_{m} ) {=}^{△} \frac{1}{m} {{\sum }^{m}}_{i = 1} g ( {x}_{i} )$$

may be the empirical coverage, where f is the prediction function, g is the selection function, c is the target coverage, lambda is a balancing hyper parameter, and psi is a quadratic penalty function.

In some embodiments, during machine learning training, loss contributions of respective input data records may be weighted by the selection score (e.g., an output of the selective residual LSTM network illustrated in FIG. 3). Based on features described with reference to FIG. 3, training a selective residual LSTM network may: (i) provide that the selective residual LSTM network recognize when to abstain from conducting operations based on irregular sequences of data records; and/or (ii) configure the machine learning model to focus conduct optimization operations based on subset of data records for which resource allocations may be made. In some embodiments, the selective residual LSTM may be trained based on an integrated reject option.

In some scenarios, optimizing machine learning models based only on selected training samples may contribute to over-fitting. Accordingly, in some embodiments, machine learning models may include an auxiliary head configured to be optimized over an entire sequence of data records. In some situations, the final network loss may be a convex combination of the selective prediction loss and the auxiliary loss:

$$ℒ = {αℒ}_{( f , g )} + ( 1 - α ) {ℒ}_{h}$$

$${ℒ}_{h} = \hat{r} ( h \vert {S}_{m} ) = \frac{1}{m} {{\sum }^{m}}_{i = 1} ℓ ( h ( {x}_{i} ) , {y}_{i} ) .$$

In some situations, an auxiliary loss may provide or add a degree of regularization (e.g., being a source of regularization).

In some embodiments, machine learning models described in the present disclosure may be configured to conduct operations without considering the above-described auxiliary loss component.

In some situations, the resource application 112 having machine learning model architecture may generate forecasted resource allocation values that may be coarse grain values (e.g., predicted monetary transaction amounts rounded to the nearest dollar). Such forecasted resource allocation values may be based on observed outlier input data record values. It may be beneficial to provide machine learning models for generating forecasted resource allocation values with greater precision, thereby facilitating downstream operations such as auto-population of forecasted resource allocation values.

In some examples, systems may be configured to conduct “snapping” operations, such as “snapping the predicted amount to the closest previously observed amount with at least N occurrences” or “snapping the predicted amount to the previous amount if the relative differences is less than X %”. In some situations, the above-described operations may be otherwise influenced by outlier input data set records. It may be beneficial to configure machine learning models by guiding embodiments of the LSTM networks to predict forecasted resource allocation transactions with increased precision. In examples where the resource may be currency, it may be beneficial to configure machine learning models to predict forecasted resource allocation values with precision to a nearest cent (e.g., 1/100^{th} of a dollar).

In some embodiments, the system 100 may conduct operations associated with self-attention, thereby enabling machine learning model operations to forecast resource allocation transactions with increased accuracy. In some embodiments, operations for self-attention may relate different positions within a single sequence of data records. Such operations may be related to operations of a Transformer model in natural language processing.

In some embodiments, the system 100 may be configured to generate predicted resource allocation based on a learned, dynamic weighted average of previously observed resource allocation values. For example, at time step t, the system 100 may conduct operations to utilize a current LSTM output representation as the query, the LSTM output representations from time steps 1 to t−1 as the keys, and the amounts from time steps 2 to t as the values. In some examples, such operations may be related to operations of query-key-value attention. The system 100 may conduct operations such that the amount prediction is a weighted average of previously observed amounts, where the weights are determined by the similarity of the current time step LSTM output representation to the previous time step LSTM output representations.

In some embodiments, the amounts and LSTM output representations may be utilized without additional projections. To control the sharpness of the softmax outputs (i.e. the similarity scores) without learned projections, the system 100 may be configured to make the scaling factor in the softmax learnable instead of fixed, observing that the scaling factor may be interpreted as a temperature parameter. The learnable parameter may allow the sharpness of the similarity scores to be driven by the network loss.

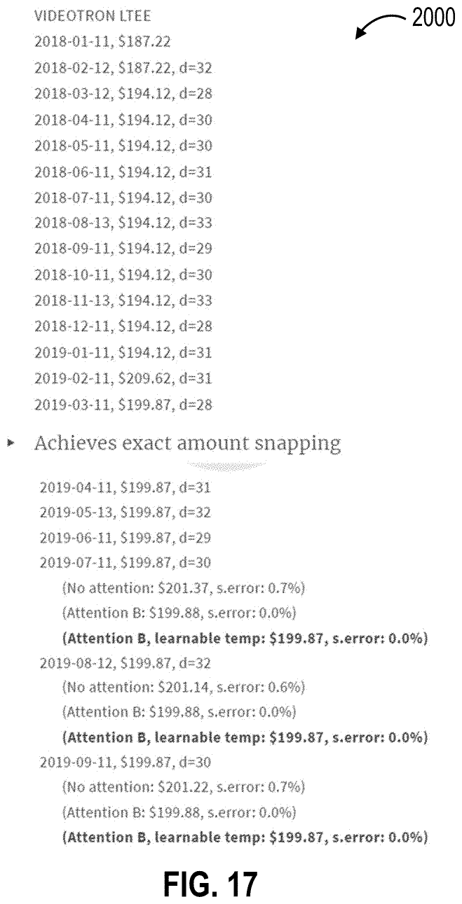

FIGS. 17 to 20 are illustrations showing the effect of self-attention, in contrast with operations conducted without self-attention.

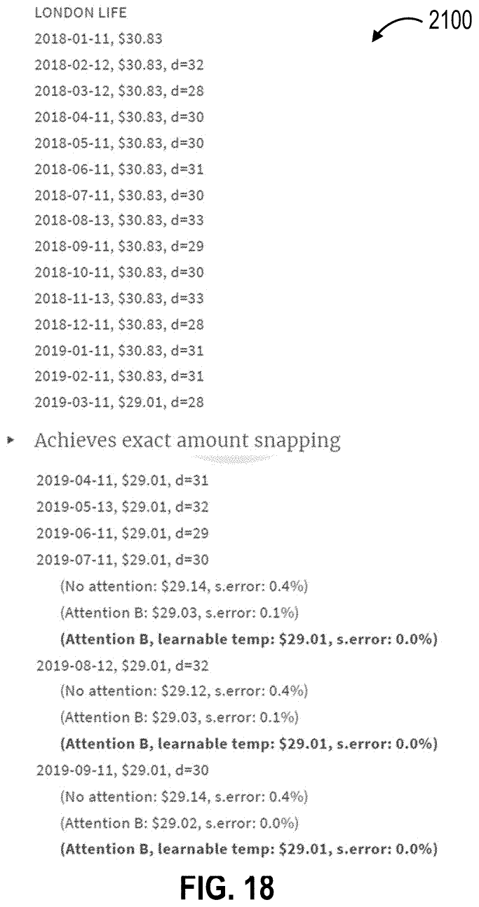

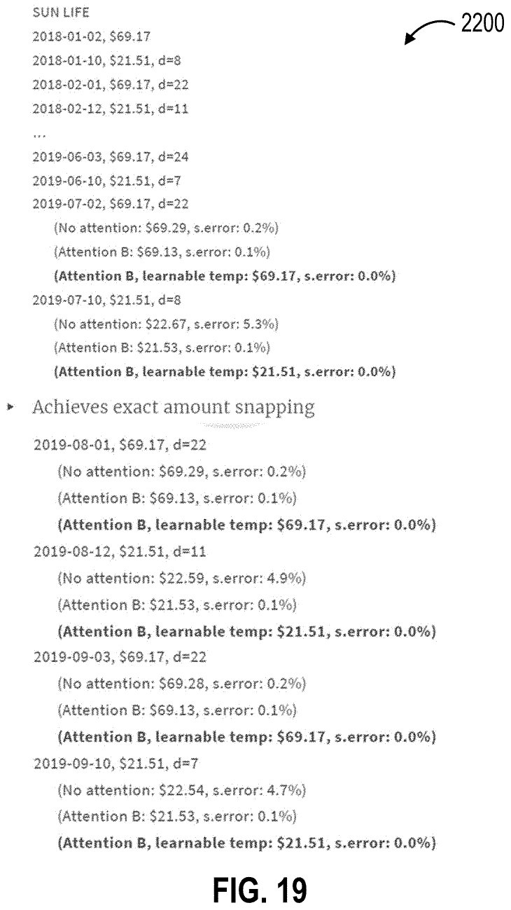

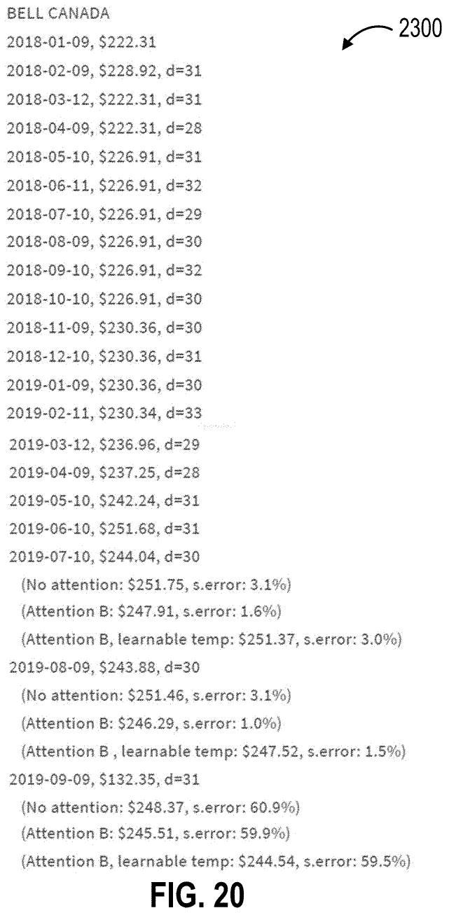

FIG. 17 shows an example set of data records 2000 from a store with the effect of self-attention. FIG. 18 an example set of data records 2100 from an insurance company with the effect of self-attention. FIG. 19 shows an example set of data records 2200 from another insurance company with the effect of self-attention. FIG. 20 shows an example set of data records 2300 from a utility company with the effect of self-attention.

In some embodiments, to increase efficiency of machine learning model training operations, the system 100 may be configured to randomly sample a subset of user data records associated with user accounts. In some embodiments, the system 100 may train the machine learning model using an ADAM optimizer. The base loss, described in the present disclosure, may be a convex combination of a date prediction loss and an amount prediction loss, i.e., =βlₐₘₒᵤₙₜₛ+(1−β)l_{dates}. The date prediction loss l_{dates} may be the L1 loss (mean absolute error) on the date-deltas. The amount prediction loss lₐₘₒᵤₙₜₛ may be the symmetric mean absolute percentage error (sMAPE) on the amounts.

In some embodiments, the system 100 may be configured such that the convex combination may be replaced with multi-task learning, which may adjust the fusion weights dynamically based on task difficulty or progress.

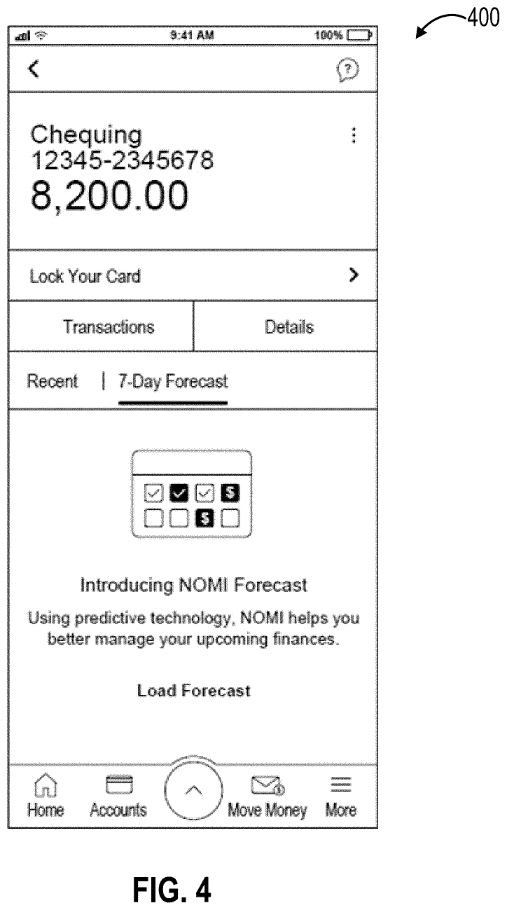

Reference is made to FIGS. 4 to 7, which illustrate user interfaces associated with displaying forecasts of prospective resource allocations associated with a future point in time, in accordance with embodiments of the present disclosure.

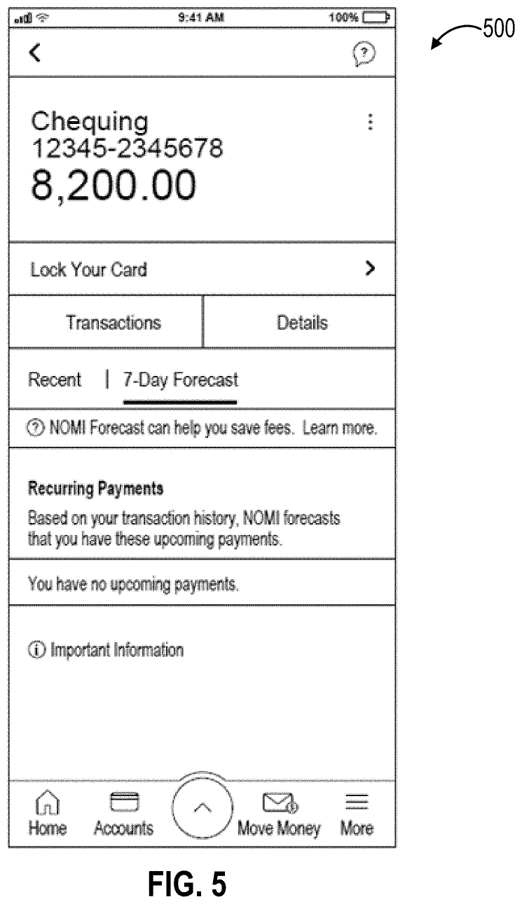

For example, FIGS. 4 and 5 illustrate user interfaces (400, 500) for display at a client device 130 (FIG. 1). The user interfaces may be associated with a user's banking account, and the user interfaces may be application landing pages associated with the resource application 112 (FIG. 1).

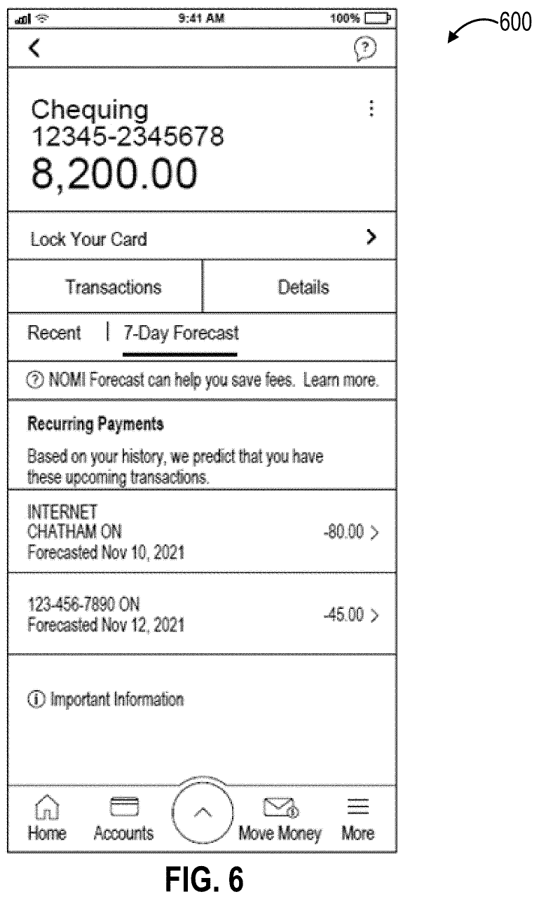

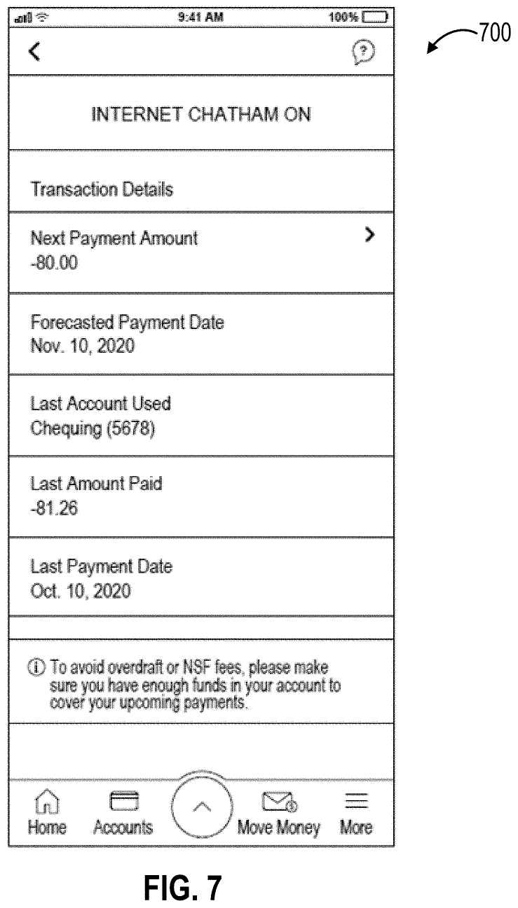

FIGS. 6 and 7 illustrate user interfaces (600, 700) for display at a client device 130. In FIGS. 6 and 7, one or more predictions of forecasted resource allocation values for a future point in time may be provided. For instance, FIG. 6 illustrates predicted resource allocation values of an Internet utility service invoice and a cellular service invoice based on embodiments of machine learning models described in the present disclosure. The machine learning models may be based on data sets representing prior resource allocation values at prior points in time.

In FIG. 7, the client device 130 may display a user interface 700 showing further details of respective predicted resource allocation values associated with payee entities.

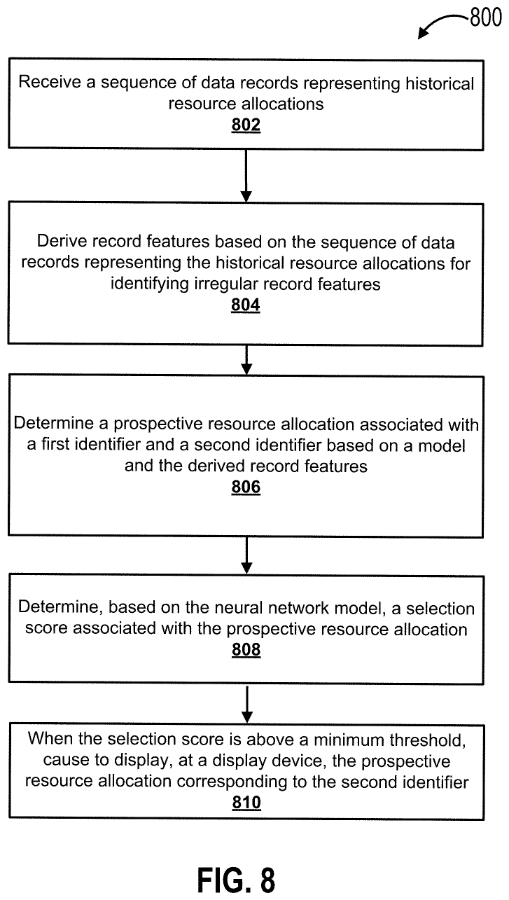

Reference is made to FIG. 8, which illustrates a method 800 of forecasting prospective resource allocations at a future point in time, in accordance with embodiments of the present disclosure. The method 800 may be conducted by the processor 102 of the system 100 (FIG. 1). Processor-executable instructions may be stored in the memory 106 and may be associated with the resource application 112 or other processor-executable applications not illustrated in FIG. 1. The method 800 may include operations such as data retrievals, data manipulations, data storage, or other operations, and may include computer-executable operations.

At operation 802, the processor may receive a sequence of data records representing historical resource allocations from a user associated with a first identifier to another user associated with a second identifier. Respective data records may include a resource value, a date/time stamp, or other featured data value.

At operation 804, the processor may derive record features based on the sequence of data records representing the historical resource allocations for identifying irregular record features. In some embodiments, record features may include identifying time intervals between successive and adjacent data records in the sequence. Other record features may be derived. In some embodiments, irregular record features identified among the sequence of data records may include identifying one or more data records representing infrequent bill payments for credit card accounts, one or more sequences of data records representing with several missed payments or extra payments, or one or more sequences of data records representing unclear billing intervals.

At operation 806, the processor may determine a prospective resource allocation associated with the first identifier and the second identifier based on a neural network model and the derived record features. The neural network model may be based on a residual long short-term memory (LSTM) network including blocks of stacked LSTMs with residual connections between blocks.

For example, a bill payment from a user named Bob to a hydro-electric company (e.g., Quebec Hydro) may be made on a monthly basis. In some examples, at operation 806, the processor may generate prospective resource allocations associated with the hydro-electric company (as payee). Other example prospective resource allocations may be used.

In some embodiments, based on the selection score, the processor may associate a weight with an identified data record corresponding to an irregular record feature. In some examples, a zero weight being associated with the identified data record corresponding to the irregular record feature may be for abstaining from generating a prospective resource allocation.

The neural network model may, in some embodiments, include an integrated reject parameter for providing a selection score.

In some embodiments, the neural network model is configured to generate one or more outputs associated with one or more time steps, the one or more outputs including a predicted date-delta, a predicted normalized amount, the selection score, and auxiliary predictions including an auxiliary amount and an auxiliary date.

In some embodiments, the neural network model is configured to generate one or more outputs associated with one or more time steps, the one or more outputs including a predicted date-delta, a predicted normalized amount, the selection score, and auxiliary predictions including an auxiliary amount and an auxiliary date.

In some embodiments, the neural network model is trained based on the auxiliary amount and the auxiliary date.

In some embodiments, a weight may be assigned to an identified data record corresponding to an irregular record feature.

In some embodiments, a zero weight may be assigned the identified data record corresponding to the irregular record feature for abstaining from generating a prospective resource allocation.

In some embodiments, an adjusted prospective resource allocation may be generated corresponding to the second identifier based on self-attention operations to provide the adjusted prospective resource allocations as being a dynamic weighted average of prior observed resource allocation values.

In some embodiments, the processor may conduct operations to abstain from generating the prospective resource allocation in response to an identified data record having an irregular feature. For example, the processor may determine whether to generate or to abstain from generating a prospective resource allocation subsequent to a respective observation or time step corresponding to a sequence of data records. The processor may abstain from generating the prospective resource allocation in response to identifying a data record having an irregular feature. Irregular features may be associated with infrequent resource allocations (e.g., infrequent bill payments), sequences of missed or sequences of extra payments, or sequences having unclear billing intervals. Other examples of irregular features or other examples of abstaining from generating prospective resources allocations may be contemplated.

In some embodiments, the processor may generate one or more adjusted prospective resource allocations corresponding to the second identifier based on self-attention operations, where the adjusted prospective resource allocations comprise a dynamic weighted average of prior observed resource allocation values.

In some embodiments, the neural network model is associated with a network loss including a selective prediction loss expressed as:

$$\begin{matrix}{ℒ}_{( f , g )} {=}^{△} {\hat{r}}_{ℓ} ( f , g \vert {S}_{m} ) + λΨ ( c - \hat{ϕ} ( g \vert {S}_{m} ) ) \\ Ψ ( a ) {=}^{△} max {( 0 , a )}^{2} ,\end{matrix}$$

$$wherein$$

$$\hat{r} ( f , g \vert {S}_{m} ) {=}^{△} \frac{\frac{1}{m} {\sum }_{i = 1}^{m} ℓ ( f ( {x}_{i} ) , {y}_{i} ) g ( {x}_{i} )}{\hat{ϕ} ( g \vert {S}_{m} )}$$

is a selective empirical risk, and

$$\hat{ϕ} ( g \vert {S}_{m} ) {=}^{△} \frac{1}{m} {{\sum }^{m}}_{i = 1} g ( {x}_{i} )$$

is a empirical coverage, f is a prediction function, g is a selection function for generating the selection score, c is a target coverage, lambda is a balancing hyper parameter, and psi is a quadratic penalty function.

In some embodiments, the network loss includes a combination of the selective prediction loss and an auxiliary loss expressed as:

$$ℒ = {αℒ}_{( f , g )} + ( 1 - α ) {ℒ}_{h}$$

$$wherein$$

$${ℒ}_{h} = \hat{r} ( h \vert {S}_{m} ) = \frac{1}{m} {{\sum }^{m}}_{i = 1} ℓ ( h ( {x}_{i} ) , {y}_{i} ) .$$

At operation 808, the processor may generate, based on the neural network model, a selection score associated with the prospective resource allocation. For example, the selection score may be a real value between 0 and 1. A threshold may be set to 0.5 or another suitable value, and long as the selection value is above the threshold value, the associated prospective resource allocation may be stored as a valid prediction.

At operation 810, the processor may, when the selection score is above a minimum threshold (e.g., 0.5), cause to display, at a display device (e.g., a display of the client device 130), the prospective resource allocation corresponding to the second identifier.

For example, the resource allocation may be an allocation of purchase orders, allocation of electricity or water, allocation of financial resources, or allocation of vaccine supplies.

In some embodiments, the generated prospective resource allocations may be obtained by other operations or applications for downstream applications. For example, the generated prospective resource allocations may be for display on user interfaces (see e.g., FIGS. 6 and 7). In another example, the generated prospective resource allocations may be obtained by other applications for identifying cash flow metrics at a future point in time based at least in part on the predicted/generated prospective resource allocations.

The term “connected” or “coupled to” may include both direct coupling (in which two elements that are coupled to each other contact each other) and indirect coupling (in which at least one additional element is located between the two elements).

Each computing devices may be connected in various ways including directly coupled, indirectly coupled via a network, and distributed over a wide geographic area and connected via a network (which may be referred to as “cloud computing”).

For example, and without limitation, each computing device may be a server, network appliance, set-top box, embedded device, computer expansion module, personal computer, laptop, personal data assistant, cellular telephone, smartphone device, UMPC tablets, video display terminal, gaming console, electronic reading device, and wireless hypermedia device or any other computing device capable of being configured to carry out the methods described herein.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The foregoing discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

The embodiments and examples described herein are illustrative and non-limiting. Practical implementation of the features may incorporate a combination of some or all of the aspects, and features described herein should not be taken as indications of future or existing product plans. Applicant partakes in both foundational and applied research, and in some cases, the features described are developed on an exploratory basis.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A system for machine learning architecture for prospective resource allocations comprising:
a processor; and
a memory coupled to the processor and storing processor-executable instructions that, when executed, configure the processor to:
receive a sequence of data records representing historical resource allocations from a user associated with a first identifier to another user associated with a second identifier;
derive record features based on the sequence of data records representing the historical resource allocations for identifying irregular record features;
determine a prospective resource allocation associated with the first identifier and the second identifier based on a neural network model and the derived record features;
determine, based on the neural network model, a selection score associated with the prospective resource allocation; and
when the selection score is above a minimum threshold, cause to display, at a display device, the prospective resource allocation corresponding to the second identifier.

2. The system of claim 1, wherein the neural network model is based on a residual long short-term memory (LSTM) network including blocks of stacked LSTMs with residual connections between blocks.

3. The system of claim 2, wherein the neural network model is configured to generate one or more outputs associated with one or more time steps, the one or more outputs comprising a predicted date-delta, a predicted normalized amount, the selection score, and an auxiliary prediction including an auxiliary amount and an auxiliary date.

4. The system of claim 3, wherein training of the neural network model is based on the auxiliary amount and the auxiliary date.

5. The system of claim 3, wherein the processor-executable instructions, when executed, configure the processor to:
based on the selection score, associate a weight with an identified data record corresponding to an irregular record feature.

6. The system of claim 5, wherein associating a zero weight to the identified data record marks the identified data record as the irregular record feature for abstaining from generating a prospective resource allocation.

7. The system of claim 1, wherein the processor-executable instructions, when executed, configure the processor to:
generate one or more adjusted prospective resource allocations corresponding to the second identifier based on self-attention operations, wherein the adjusted prospective resource allocations comprise a dynamic weighted average of prior observed resource allocation values.

8. The system of claim 1, wherein the neural network model is associated with a network loss including a selective prediction loss expressed as:
$$\begin{matrix}{ℒ}_{( f , g )} {=}^{△} {\hat{r}}_{ℓ} ( f , g \vert {S}_{m} ) + λΨ ( c - \hat{ϕ} ( g \vert {S}_{m} ) ) \\ Ψ ( a ) {=}^{△} max {( 0 , a )}^{2} ,\end{matrix}$$
$$wherein$$
$$\hat{r} ( f , g \vert {S}_{m} ) {=}^{△} \frac{\frac{1}{m} {\sum }_{i = 1}^{m} ℓ ( f ( {x}_{i} ) , {y}_{i} ) g ( {x}_{i} )}{\hat{ϕ} ( g \vert {S}_{m} )}$$
is a selective empirical risk, and
$$\hat{ϕ} ( g \vert {S}_{m} ) {=}^{△} \frac{1}{m} {{\sum }^{m}}_{i = 1} g ( {x}_{i} )$$
is a empirical coverage, f is a prediction function, g is a selection function for generating the selection score, c is a target coverage, lambda is a balancing hyper parameter, and psi is a quadratic penalty function.

9. The system of claim 8, wherein the network loss includes a combination of the selective prediction loss and an auxiliary loss expressed as:
$$ℒ = {αℒ}_{( f , g )} + ( 1 - α ) {ℒ}_{h}$$
$$wherein$$
$${ℒ}_{h} = \hat{r} ( h \vert {S}_{m} ) = \frac{1}{m} {{\sum }^{m}}_{i = 1} ℓ ( h ( {x}_{i} ) , {y}_{i} ) .$$

10. A computer-implemented method for machine learning architecture for prospective resource allocation, the method comprising:
receiving a sequence of data records representing historical resource allocations from a user associated with a first identifier to another user associated with a second identifier;
deriving record features based on the sequence of data records representing the historical resource allocations for identifying irregular record features;
determining a prospective resource allocation associated with the first identifier and the second identifier based on a neural network model and the derived record features;
determining, based on the neural network model, a selection score associated with the prospective resource allocation; and
when the selection score is above a minimum threshold, causing to display, at a display device, the prospective resource allocation corresponding to the second identifier.

11. The method of claim 10, wherein the neural network model is based on a residual long short-term memory (LSTM) network including blocks of stacked LSTMs with residual connections between blocks.

12. The method of claim 11, wherein the neural network model is configured to generate one or more outputs associated with one or more time steps, the one or more outputs comprising a predicted date-delta, a predicted normalized amount, the selection score, and an auxiliary prediction including an auxiliary amount and an auxiliary date.

13. The method of claim 12, wherein training of the neural network model is based on the auxiliary amount and the auxiliary date.

14. The method of claim 12, further comprising:
based on the selection score, associating a weight with an identified data record corresponding to an irregular record feature.

15. The method of claim 14, wherein associating a zero weight to the identified data record marks the identified data record as the irregular record feature for abstaining from generating a prospective resource allocation.

16. The method of claim 10, further comprising:
generating one or more adjusted prospective resource allocations corresponding to the second identifier based on self-attention operations, wherein the adjusted prospective resource allocations comprise a dynamic weighted average of prior observed resource allocation values.

17. The method of claim 10, wherein the neural network model is associated with a network loss including a selective prediction loss expressed as:
$$\begin{matrix}{ℒ}_{( f , g )} {=}^{△} {\hat{r}}_{ℓ} ( f , g \vert {S}_{m} ) + λΨ ( c - \hat{ϕ} ( g \vert {S}_{m} ) ) \\ Ψ ( a ) {=}^{△} max {( 0 , a )}^{2} ,\end{matrix}$$
$$wherein$$
$$\hat{r} ( f , g \vert {S}_{m} ) {=}^{△} \frac{\frac{1}{m} {\sum }_{i = 1}^{m} ℓ ( f ( {x}_{i} ) , {y}_{i} ) g ( {x}_{i} )}{\hat{ϕ} ( g \vert {S}_{m} )}$$
is a selective empirical risk, and
$$\hat{ϕ} ( g \vert {S}_{m} ) {=}^{△} \frac{1}{m} {{\sum }^{m}}_{i = 1} g ( {x}_{i} )$$
is a empirical coverage, f is a prediction function, g is a selection function for generating the selection score, c is a target coverage, lambda is a balancing hyper parameter, and psi is a quadratic penalty function.

18. The method of claim 17, wherein the network loss includes a combination of the selective prediction loss and an auxiliary loss expressed as:
$$ℒ = {αℒ}_{( f , g )} + ( 1 - α ) {ℒ}_{h}$$
$$wherein$$
$${ℒ}_{h} = \hat{r} ( h \vert {S}_{m} ) = \frac{1}{m} {{\sum }^{m}}_{i = 1} ℓ ( h ( {x}_{i} ) , {y}_{i} ) .$$

19. A non-transitory computer-readable medium having stored thereon machine interpretable instructions which, when executed by a processor, cause the processor to perform:
receiving a sequence of data records representing historical resource allocations from a user associated with a first identifier to another user associated with a second identifier;
deriving record features based on the sequence of data records representing the historical resource allocations for identifying irregular record features;
determining a prospective resource allocation associated with the first identifier and the second identifier based on a neural network model and the derived record features;
determining, based on the neural network model, a selection score associated with the prospective resource allocation; and
when the selection score is above a minimum threshold, causing to display, at a display device, the prospective resource allocation corresponding to the second identifier.

20. The computer-readable medium of claim 19, wherein the neural network model is based on a residual long short-term memory (LSTM) network including blocks of stacked LSTMs with residual connections between blocks.
